(19) United States
(12) Patent Application Publication
(10) Pub. No.: US 2004/0179044 A1
(43) Pub. Date: Sep. 16, 2004

(54) Method, system, and computer program product for providing visual assistance in display of information on a display device

(75) Inventors: William Stephen Carter, Round Rock, TX (US); Herman Rodriguez, Austin, TX (US); Hypatia Rojas, Round Rock, TX (US)

Correspondence Address: Mark D. Simpson, Synnestvedt & Lechner LLP, 2600 Aramark Tower, 1101 Market Street, Philadelphia, PA, 19107-2950, US

(73) Assignee: International Business Machines Corp., Armonk, NY

(21) Appl. No.: 10/388,952

(22) Filed: Mar. 13, 2003

(51) Int. Cl. G09G 5/00

(52) U.S. Cl. 345/865

(57) ABSTRACT

A method and system for allowing a user of a computer program to select an option whereby adjacent characters in written words are automatically distinguished from each other on the screen. Variations in font size, color, appearance (e.g., blinking) are some examples of the types of variations proposed, as well as combinations thereof. By allowing variation of the characters of a word on a written page, each individual character receives independent focus by the user rather than having all of the characters receiving a “group” focus. This assists users with visual disabilities, such as dyslexia, in reading and writing on a computer screen.

### BACKGROUND OF THE INVENTION

1. Field of the Invention

The present invention relates to assistance technology for visual disabilities and, more particularly, to a method and system for assisting computer users with the use of written words on a computer screen.

2. Description of the Related Art

It is estimated that 40% of the population has some form of dyslexia, a handicap that impairs the brain's ability to translate images received from the eyes and ears into understandable language. Visual dyslexia is characterized in numerous manners, and frequently by number and letter reversals and the inability to write letters in the correct sequence.

Most word processing programs and graphical user interfaces (GUIs) have limited mechanisms for altering or customizing the display of characters on the screen. Background colors and text colors can be manually changed, and the size of fonts used for the text on a page can be manually increased or decreased as desired. Spell checkers can help, to some degree, with the correction of the spelling of words, but there are numerous situations where the incorrect spelling of a word desired to be written by a user is, itself, the correct spelling of a different word (e.g., “saw” and “was”).

Increasing the text size of all characters on a display can help a dyslexic person see characters more easily. However, since all of the characters are increased to the same size, the dyslexic person may not be able to easily focus on or isolate an individual character in a word to identify the incorrect letter sequence. For example, if a person with dyslexia wishes to write the word “was” and instead types the word “saw”, their brain may process the letters forming the word as being correct, since the correct three letters appear in the word, even though they are not in the desired order; having all three letters enlarged simultaneously may not cause them to process it any differently and thus it is unlikely that the person will notice the error.

Accordingly, it would be desirable to have a system and method for automatically displaying certain characters on a display device in a format that contrasts them from other characters so that, for example, each letter of a word receives individual emphasis as compared to the other letters in the word.

### SUMMARY OF THE INVENTION

The present invention provides a method and system for allowing a user of a computer program to select an option whereby adjacent characters in written words are automatically distinguished from each other on the screen. Variations in font size, color, appearance (e.g., blinking) are some examples of the types of variations proposed, as well as combinations thereof. By allowing variation of the characters of a word on a written page, each individual character receives independent focus by the user rather than having all of the characters receiving a “group” focus. This assists users with visual disabilities, such as dyslexia, in reading and writing on a computer screen.

### BRIEF DESCRIPTION OF THE DRAWINGS

FIGS. 1a through 1f illustrate a sequence of input characters and how they are displayed on a display device in accordance with the present invention;

FIGS. 2a through 2f illustrate a second embodiment of the present invention; and

FIG. 3 is a flowchart illustrating the steps performed to achieve the present invention;

### DETAILED DESCRIPTION OF THE PREFERRED EMBODIMENTS

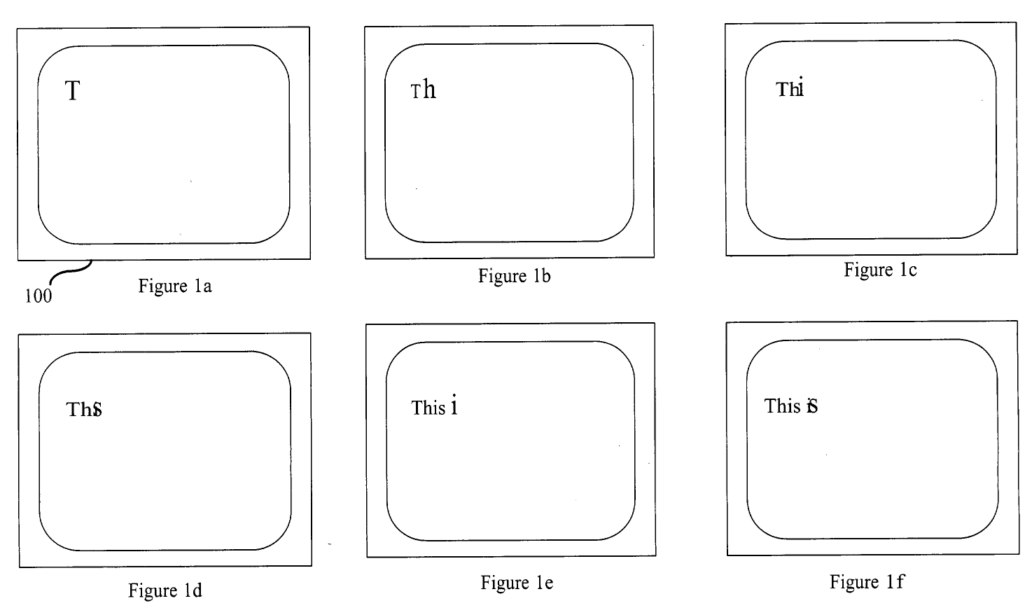

FIGS. 1a through 1f illustrate a sequence of input characters and how they are displayed on a display device 100 (e.g., a computer monitor, cell phone screen, etc.) in accordance with the present invention. Referring to FIG. 1a-1f, assume that a user of the monitor wishes to input the following text:

“This is an example of text on the screen as it might be viewed by one using this invention.”

In FIG. 1a, the user has typed the first letter “T”. As can be seen, the letter “T” appears in bold font and is of relatively large size. In FIG. 1b, the user has depressed the “h” key and the initial letter “T” has now decreased to “normal text”, i.e., regular non-bold type and a smaller size, while the newly depressed letter “h” has increased in size and is bold. FIG. 1c illustrates the typing of the character “i”; FIG. 1d illustrates the typing of the letter “s”; FIG. 1e illustrates the typing of the letter “i” at the beginning of the second word; and FIG. 1f illustrates the typing of the “s” character of the second word.

The character to be enhanced is referred to herein as the “target character”. As can be seen, the target character in this example is always displayed in an increased size and more prominent typeface, and as a new target letter is displayed, the other letters (including the previous target letter) are displayed in a normal typeface. This draws the user's attention to the single character being typed as opposed to the character groupings that form the complete word as is done in the prior art. Using this typing method, the user is more likely to concentrate on the individual character and thus, when attempting to type the word “was” (but instead starting to type the word “saw”), they will be more aware when they see the initial character “s” in the word “saw” displayed prominently as they type.

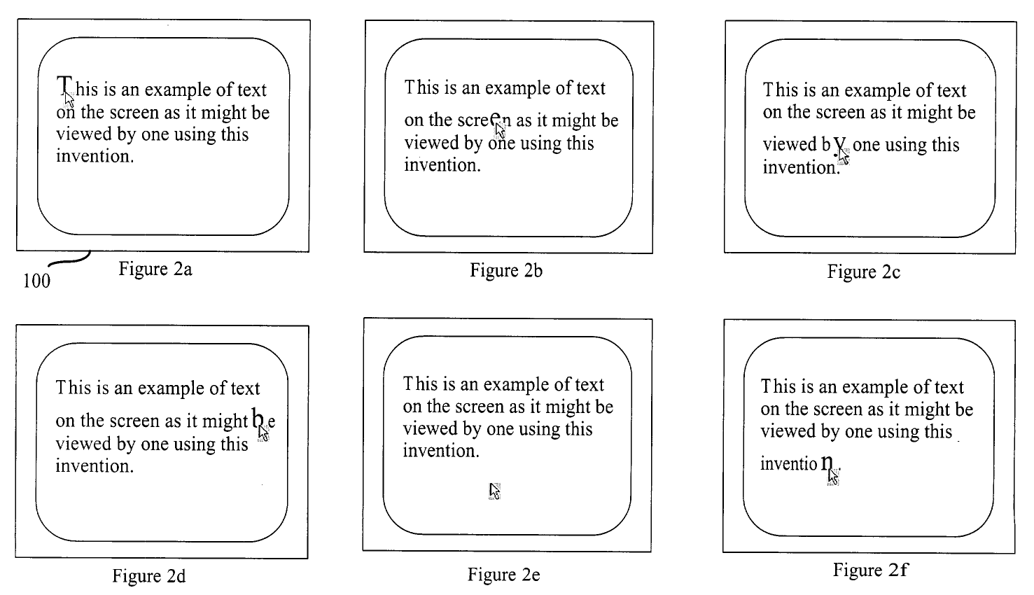

FIGS. 2a through 2f illustrate a second embodiment of the present invention. In this embodiment, the text has already been typed and the user uses the mouse key to hover over the characters on the screen. As the mouse is hovered over a particular character, the typeface of the character is switched to bold and the text size is increased. Thus, as can be seen in FIG. 2a, for example, the mouse is hovering over the letter “T” in the first word and this letter has been highlighted and increased in size; in FIG. 2b, the second letter “e” of the word “screen” is bolded and enlarged as the mouse hovers over that character; similar examples are shown in FIGS. 2c, 2d, 2f. FIG. 2e illustrates that the text is all shown in “normal” size when the mouse is not hovering over any of the characters.

The examples shown above utilize a larger and bold font, relative to the non-target characters, to emphasize the target characters. It is understood that numerous other methods of emphasizing the target character can be used, for example, by blinking the character, changing its color, dimming all characters but the target character, changing the “background” color behind the target character, etc. Further, it is understood that any combination of the contemplated methods for emphasizing the target character can be combined so that they occur simultaneously (e.g., increase in size and changing of color, for example). In addition, other emphasis can be provided, such as making a character in the word in which the target letter appears be of a different color than the rest of the text while also emphasizing the target character in a different manner (e.g., increased size).

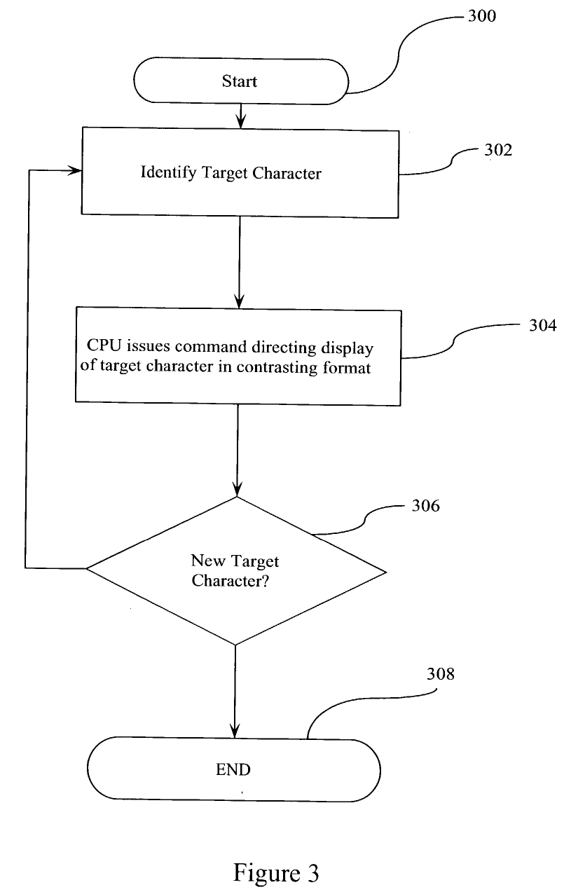

FIG. 3 is a flowchart illustrating the steps performed to achieve the present invention. The process begins at step 300, with the user having selected from a preferences menu, for example, a “display target character in contrasting text” selection. This selection can take many forms and could instead, for example, be directed to a user with a specific condition (e.g., a “dyslexic-friendly” selection) or can be more general in nature (e.g., an “enhance target character” selection). Further, any known method for selection of the display option can be utilized; a “preferences” menu selection is just one of many known selection methods and it is understood that many other selection methods will be readily apparent to one of ordinary skill in the art and such methods are considered to be part of the disclosure herein.

In the selected mode, the system will continually monitor to identify target characters. In the example given with respect to FIGS. 1a-1f, this will involve, in a text-entry mode, having the character at the position immediately preceding the cursor displayed in the contrasting format and having all other text being displayed in “normal” format.

At step 302, a target character is identified, and at step 304, the CPU issues the command directing the display of the target character in the contrasting format. In a text-entry mode, this will involve increasing the size, changing the color, blinking, or otherwise displaying the character currently typed by the user (or immediately preceding the cursor) in the contrasting format. In the “hovering mode”, this will involve displaying any character over which the mouse pointer is hovering in the contrasting format. As discussed below, these actions can be implemented using well-known programming techniques.

At step 306, a determination is made as to whether there are additional target characters. In the text-entry mode, this involves identifying if a new character has been typed (or if there is a character immediately preceding the cursor that is not already enhanced); in the hovering mode, this simply involves the identification of the mouse pointer hovering over a different character than one that is already enhanced. If there is a new target character identified, the process proceeds back to step 302 where the target character is identified and then to step 304 where the CPU issues the command directing the display of the target character in the contrasting format. If there are no additional target characters, the process ends at step 308.

The above-described steps can be implemented using standard well-known programming techniques. The novelty of the above-described embodiment lies not in the specific programming techniques but in the use of the steps described to achieve the described results. Software programming code that embodies the present invention is typically stored in permanent storage of some type, such as permanent storage of the CPU controlling the display of the characters of the display device. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, FIGS. 1-3 support combinations of means for performing the specified functions, combinations of steps for performing the specified functions, and program instruction means for performing the specified functions.

Although the present invention has been described with respect to a specific preferred embodiment thereof, various changes and modifications may be suggested to one skilled in the art and it is intended that the present invention encompass such changes and modifications as fall within the scope of the appended claims.

We claim:

1. A method of distinguishing between two or more characters displayed on a display device, comprising the steps of:
selecting one of said characters as a target character;
automatically modifying the appearance of said target character so that it has an appearance different from any other characters displayed on said display device; and
automatically returning said target character to its unmodified appearance when it is no longer the target character.

2. The method of claim 1, wherein said selection step comprises the step of selecting as said target character a character immediately preceding a cursor displayed on said display device at any time.

3. The method of claim 2, wherein said appearance modification comprises changing the display of said target character from normal-sized font to a larger-sized font.

4. The method of claim 2, wherein said appearance modification comprises changing the display of said target character from a normal color font to a color other than said normal color.

5. The method of claim 2, wherein said appearance modification comprises changing the display of said target character from a non-blinking character to a blinking character.

6. The method of claim 2, wherein said appearance modification comprises changing the display of said target character from a normal color font and normal-sized font to a larger-sized font of a color other than said normal color.

7. The method of claim 1, wherein said selection step comprises the step of selecting as said target character a character over which a mouse pointer displayed on said display device is positioned at any time.

8. The method of claim 7, wherein said appearance modification comprises changing the display of said target character from normal-sized font to a larger-sized font.

9. The method of claim 7, wherein said appearance modification comprises changing the display of said target character from a normal color font to a color other than said normal color.

10. The method of claim 7, wherein said appearance modification comprises changing the display of said target character from a non-blinking character to a blinking character.

11. The method of claim 7, wherein said appearance modification comprises changing the display of said target character from a normal color font and normal-sized font to a larger-sized font of a color other than said normal color.

12. The method of claim 1, further comprising the step of:
presenting a user of said display device with an option of selecting, as a preference, whether or not to perform said automatic modification step when using said display device.

13. Computer readable code stored on computer-readable medium for distinguishing between two or more characters in a graphical user interface displayed on a display device, comprising:
first subprocesses for causing one of said characters to be designated as a target character;
second subprocesses for automatically modifying the appearance of said target character so that it has an appearance different from any other characters displayed in said graphical user interface; and
third subprocesses for automatically returning said target character to its unmodified appearance when it is no longer the target character.

14. Computer-readable code for distinguishing between two or more characters according to claim 13, wherein said first subprocesses select as said target character a character immediately preceding a cursor displayed in said graphical user interface.

15. Computer-readable code for distinguishing between two or more characters according to claim 14, wherein said second subprocesses change the display of said target character from normal-size font to a larger-size font.

16. Computer-readable code for distinguishing between two or more characters according to claim 14, wherein said second subprocesses change the display of said target character from a normal color font to a color other than said normal color font.

17. Computer-readable code for distinguishing between two or more characters according to claim 14, wherein said second subprocesses change the display of said target character from a non-blinking character to a blinking character.

18. Computer-readable code for distinguishing between two or more characters according to claim 14, wherein said second subprocesses change the display of said target character from a normal color font and normal size font to a large-size font of a color other than said normal color.

19. Computer-readable code for distinguishing between two or more characters according to claim 13, wherein said first subprocesses select as said target character a character over which a mouse pointer displayed on said display device is positioned.

20. Computer-readable code for distinguishing between two or more characters according to claim 19, wherein said second subprocesses change the display of said target character from normal-size font to a larger-size font.

21. Computer-readable code for distinguishing between two or more characters according to claim 19, wherein said second subprocesses change the display of said target character from a normal color font to a color other than said normal color font.

22. Computer-readable code for distinguishing between two or more characters according to claim 19, wherein said second subprocesses change the display of said target character from a non-blinking character to a blinking character.

23. Computer-readable code for distinguishing between two or more characters according to claim 19, wherein said second subprocesses change the display of said target character from a normal color font and normal size font to a large-size font of a color other than said normal color.

24. A system for distinguishing between two or more characters displayed on a display device, comprising:
means for selecting one of said characters as a target character;
means for automatically modifying the appearance of said target character so that it has an appearance different from any other characters displayed on said display device; and
means for automatically returning said target character to its unmodified appearance when it is no longer the target character.

25. The system of claim 24, wherein said means for selection comprises means for selecting as said target character a character immediately preceding a cursor displayed on said display device at any time.

26. The system of claim 24, wherein said means for selection comprises means for selecting as said target character a character over which a mouse pointer displayed on said display device is positioned at any time.

27. A computer-implemented method of providing selective emphasis of at least one character displayed in a graphical user interface (GUI) comprising the steps of:
selecting one of said characters as a target character;
automatically modifying the appearance of said target character so that it has an appearance different from any other characters displayed on said display device; and
automatically returning said target character to its unmodified appearance when it is no longer the target character.
